(19) United States
(12) Patent Application Publication
(10) Pub. No.: US 2026/0066172 A1
(43) Pub. Date: Mar. 5, 2026

(54) CHIP ELECTRONIC COMPONENT AND ELECTRONIC COMPONENT PACKAGE

(71) Applicant: TDK CORPORATION, Tokyo (JP)

(72) Inventors: Takashi KARATSU, Tokyo (JP); Kazuya TOBITA, Tokyo (JP); Munehiro TAKAKU, Tokyo (JP); Mitsunori HIRAOKA, Tokyo (JP); Yuiko HIROSE, Tokyo (JP); Hiroto SASAKI, Tokyo (JP)

(73) Assignee: TDK CORPORATION, Tokyo (JP)

(21) Appl. No.: 19/297,688

(22) Filed: Aug. 12, 2025

(30) Foreign Application Priority Data
Aug. 30, 2024 (JP) 2024-148392

(51) Int. Cl. H01F 27/02; H01F 17/02; H01F 27/29

(52) U.S. Cl. CPC H01F 27/022; H01F 17/02; H01F 27/292

(57) ABSTRACT

A chip electronic component includes an element body and an external electrode. The element body includes a first main surface arranged to constitute a mounting surface, a second main surface opposing the first main surface, and a side surface adjacent to the first main surface and the second main surface. The external electrode includes an electrode portion that is disposed on the first main surface. The second main surface is exposed from the external electrode, and has a surface roughness larger than a surface roughness of the first main surface and larger than a surface roughness of the side surface.

### CROSS-REFERENCE TO RELATED APPLICATIONS

This application is based upon and claims the benefit of priority from Japanese Patent Application No. 2024-148392, filed on Aug. 30, 2024, the entire contents of which are incorporated herein by reference.

### BACKGROUND

### Field

The present disclosure relates to a chip electronic component and an electronic component package.

### Description of the Related Art

Known chip electronic components include an element body and an external electrode disposed on the element body (see, for example, Japanese Unexamined Patent Publication No. 2024-003627). The element body includes, for example, a first main surface arranged to constitute a mounting surface, a second main surface opposing the first main surface, and a side surface adjacent to the first main surface and the second main surface. The external electrode includes, for example, an electrode portion that is disposed on the first main surface. The second main surface is exposed from the external electrode. For example, the second main surface is not covered by the external electrode.

### SUMMARY

The chip electronic components are transported, for example, in the form of an electronic component package. The electronic component package includes a plurality of chip electronic components, a carrier tape, and a cover tape. The carrier tape has a plurality of cavities in which the plurality of chip electronic components are accommodated. The cover tape covers an opening of each cavity. Each chip electronic component is housed in the cavity such that the first main surface opposes a bottom surface of the cavity. After the chip electronic component is housed in the cavity, the cover tape is joined to the carrier tape so as to cover the opening of the cavity.

When the chip electronic component is to be mounted on an electronic device, the cover tape is peeled from the carrier tape, and the chip electronic component is picked up from the carrier tape. For example, the second main surface of the chip electronic component is attracted to a nozzle of a mounter by suction. The chip electronic component picked up by the mounter is placed at a predetermined position on the electronic device such that the first main surface opposes the electronic device. The electronic device may include, for example, a circuit board or an electronic component.

An object of one aspect of the present disclosure is to provide a chip electronic component that tends not to become electrostatically charged, even when housed in a carrier tape.

An object of another aspect of the present disclosure is to provide an electronic component package including a chip electronic component that tends not to become electrostatically charged in a carrier tape.

The present inventors, as a result of investigation and research, have newly obtained the following findings regarding the electrostatic charging of chip electronic components.

The second main surface of the chip electronic component included in the electronic component package faces the cover tape. The second main surface is exposed from the external electrode. For example, the second main surface is not covered by the external electrode. The second main surface tends to come into contact with the cover tape. For example, when transporting the chip electronic component, the chip electronic component may move within the cavity in a state where the second main surface is in contact with the cover tape. In this case, static electricity tends to be generated, and the chip electronic component (element body) may become electrostatically charged.

For example, when the cover tape is peeled from the carrier tape, static electricity may be generated. In this case as well, the chip electronic component (element body) may become electrostatically charged.

The electrostatic charging of the chip electronic component may cause mounting defects of the chip electronic component, as described below.

For example, when the cover tape is peeled from the carrier tape, the electrostatically charged chip electronic component may adhere to the cover tape and be taken away from the cavity. In this case, the chip electronic component may not be mounted on the electronic device.

For example, when the cover tape is peeled from the carrier tape, the electrostatically charged chip electronic component may rotate within the cavity in association with the peeling of the cover tape. In this case, the orientation of the chip electronic component within the cavity changes. If the orientation of the chip electronic component within the cavity changes, the second main surface may not be attracted to the nozzle by suction. If a surface other than the second main surface is attracted to the nozzle by suction, the chip electronic component may not be mounted on the electronic device such that the first main surface and the electronic device oppose each other. If the mounter cannot pick up the chip electronic component, the chip electronic component may not be mounted on the electronic device.

The present inventors have further conducted investigation and research regarding chip electronic components that tends not to become electrostatically charged. As a result, the present inventors have newly obtained the following findings.

Even in a case where the second main surface comes into contact with the cover tape, in a configuration in which the second main surface has a surface roughness larger than a surface roughness of the first main surface and larger than a surface roughness of the side surface, static electricity tends not to be generated. That is, in this configuration, electrostatic charging of the chip electronic component tends not to occur.

The present inventors, based on the newly obtained findings regarding the electrostatic charging of chip electronic components, have conceived the following aspects.

A chip electronic component according to one aspect of the present disclosure includes: an element body including a first main surface arranged to constitute a mounting surface, a second main surface opposing the first main surface, and a side surface adjacent to the first main surface and the second main surface; and an external electrode including an electrode portion that is disposed on the first main surface. The second main surface is exposed from the external electrode, and has a surface roughness larger than a surface roughness of the first main surface and larger than a surface roughness of the side surface.

An electronic component package according to another aspect of the present disclosure includes: a chip electronic component including an element body and an external electrode; a carrier tape having a cavity in which the chip electronic component is accommodated; and a cover tape that covers an opening of the cavity. The element body includes a first main surface arranged to constitute a mounting surface, a second main surface opposing the first main surface, and a side surface adjacent to the first main surface and the second main surface. The external electrode includes an electrode portion that is disposed on the first main surface. The second main surface is exposed from the external electrode, and has a surface roughness larger than a surface roughness of the first main surface and larger than a surface roughness of the side surface. The chip electronic component is housed in the cavity such that the second main surface includes a surface that faces the opening of the cavity.

### BRIEF DESCRIPTION OF THE DRAWINGS

FIG. 1 is a perspective view of a chip electronic component according to an example;

FIG. 2 is a view illustrating a cross-sectional configuration of the chip electronic component according to the example;

FIG. 3 is a view illustrating a cross-sectional configuration of the chip electronic component according to the example;

FIG. 4 is a view illustrating a cross-sectional configuration of an electronic component package;

FIG. 5 is a view illustrating a cross-sectional configuration of the electronic component package;

FIG. 6 is a view illustrating a cross-sectional configuration of an electronic component device; and

FIG. 7 is a view illustrating a cross-sectional configuration of the electronic component device.

### DETAILED DESCRIPTION

In the following description, with reference to the drawings, the same reference numbers are assigned to the same components or to similar components having the same function, and overlapping description is omitted.

### [Chip Electronic Component]

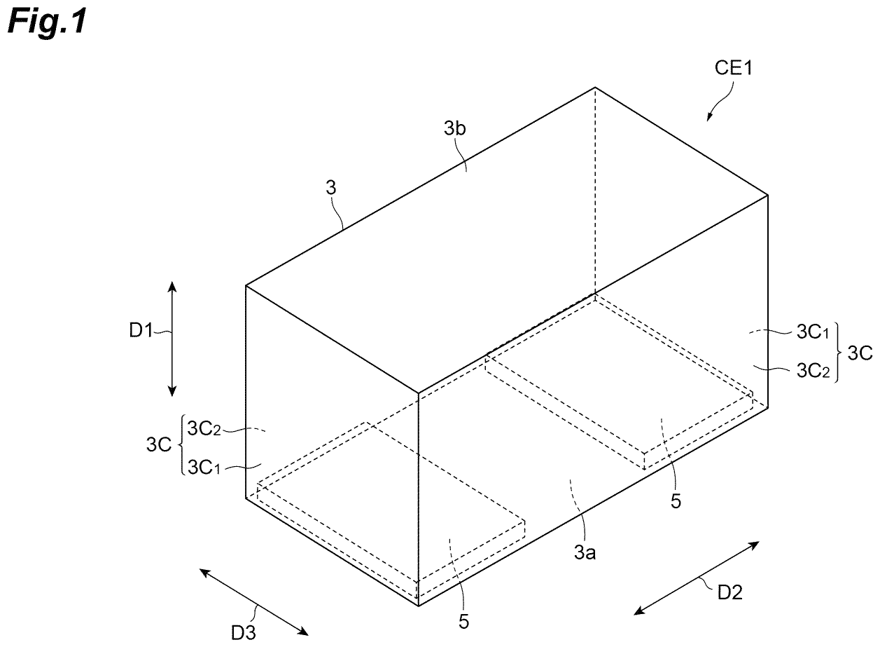

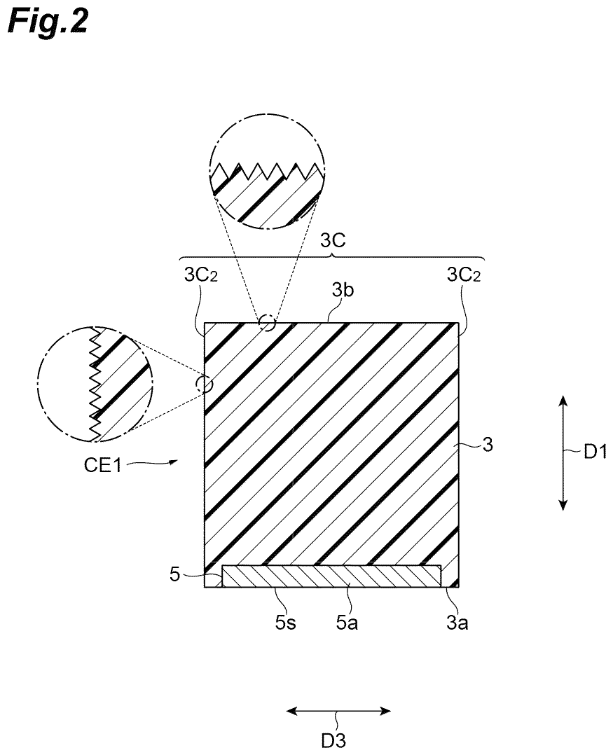

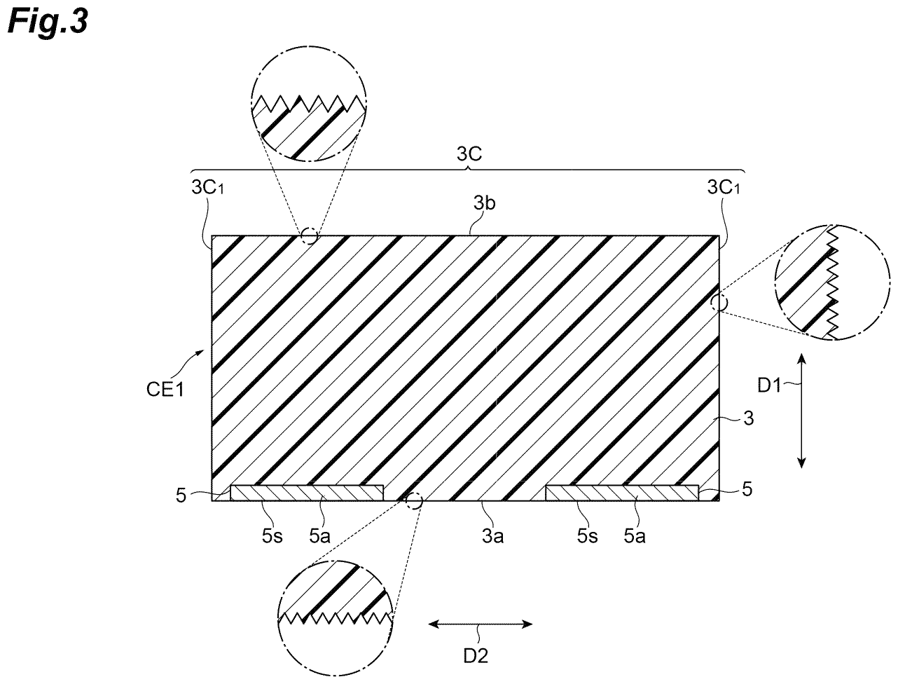

A configuration of a chip electronic component CE1 according to the example will be described with reference to FIGS. 1 to 3. FIG. 1 is a perspective view of a chip electronic component according to the example. FIGS. 2 and 3 are views illustrating a cross-sectional configuration of the chip electronic component according to the example.

The chip electronic component CE1 includes, for example, a coil component.

The chip electronic component CE1 includes an element body 3 and a plurality of external electrodes 5. The chip electronic component CE1 includes, for example, a pair of external electrodes 5. The pair of external electrodes 5 are disposed on an outer surface of the element body 3. The pair of external electrodes 5 are separated from each other. The element body 3 has, for example, a rectangular parallelepiped shape. The rectangular parallelepiped shape may include a rectangular parallelepiped shape in which corners and ridges are chamfered, or a rectangular parallelepiped shape in which the corners and ridges are rounded.

The outer surface of the element body 3 includes a pair of main surfaces 3a and 3b and a plurality of side surfaces 3c. For example, the main surfaces 3a and 3b and the side surfaces 3c each have a substantially rectangular shape. The plurality of side surfaces 3c include a pair of side surfaces 3c1 opposing each other and a pair of side surfaces 3c₂ opposing each other.

The chip electronic component CE1 is solder-mounted on an electronic device, for example. The electronic device includes, for example, a circuit board or an electronic component. In the chip electronic component CE1, for example, the main surface 3a opposes the electronic device. The main surface 3a is arranged to constitute a mounting surface. The main surfaces 3a includes the mounting surface. For example, the main surface 3a may include a first main surface, and the main surface 3b may include a second main surface.

The pair of main surfaces 3a and 3b oppose each other in a direction D1. The pair of side surfaces 3c1 oppose each other in a direction D2. The pair of side surfaces 3c2 oppose each other in a direction D3. The direction D1, the direction D2, and the direction D3 are substantially perpendicular to each other. The pair of side surfaces 3c1 extend in the direction D1 to couple the pair of main surfaces 3a and 3b. The pair of side surfaces 3c1 extend in the direction D3 to couple the pair of side surfaces 302. The pair of side surfaces 302 extend in the direction D1 to couple the pair of main surfaces 3a and 3b. The pair of side surfaces 302 extend in the direction D2 to couple the pair of side surfaces 3c1.

For example, a length of the element body 3 in the direction D2 is larger than a length of the element body 3 in the direction D1 and larger than a length of the element body 3 in the direction D3. The direction D2 includes a longitudinal direction of the element body 3. The length of the element body 3 in the direction D1 and the length of the element body 3 in the direction D3 may be equal to each other. The length of the element body 3 in the direction D1 and the length of the element body 3 in the direction D3 may be different from each other.

For example, the length of the element body 3 in the direction D1 defines a height of the element body 3. For example, the length of the element body 3 in the direction D2 defines a longitudinal length of the element body 3. For example, the length of the element body 3 in the direction D3 defines a width of the element body 3. For example, the length of the element body 3 is 0.4 mm or less, the width of the element body 3 is 0.2 mm or less, and the height of the element body 3 is 0.2 mm or less. For example, the length of the element body 3 is 0.4 mm, the width of the element body 3 is 0.2 mm, and the height of the element body 3 is 0.2 mm.

The chip electronic component CE1 has a chip size of “0402” in JIS notation. The chip electronic component CE1 has a chip size of “01005” in EIA notation. The length of the element body 3 may be 0.2 mm, the width of the element body 3 may be 0.1 mm, and the height of the element body 3 may be 0.1 mm. The chip electronic component CE1 may have a chip size “0201” in JIS notation. The chip electronic component CE1 may have a chip size “008004” in EIA notation.

The element body 3 may include ridge portions positioned between the main surface 3a and the side surfaces 3c, ridge portions positioned between the main surface 3b and the side surfaces 3c, and ridge portions positioned between the side surfaces 3c1 and the side surfaces 3c2. For example, the ridge portions may be rounded to be curved. The element body 3 may be subjected to what is called a round chamfering process. The main surface 3a and the side surface 3c may be indirectly adjacent to each other with the ridge portion positioned between the main surface 3a and the side surface 3c. The main surface 3b and the side surface 3c may be indirectly adjacent to each other with the ridge portion positioned between the main surface 3b and the side surface 3c. The side surfaces 3c1 and 302 may be indirectly adjacent to each other with the ridge portion positioned between the side surfaces 3c1 and 3c2.

The element body 3 includes, for example, an element body made of resin. The element body 3 may include an element body made only of resin.

The element body 3 includes, for example, a plurality of element body layers. For example, the plurality of element body layers are laminated in the direction D1. In the actual element body 3, the plurality of element body layers may be integrated to such an extent that the boundaries between the layers are not visually recognizable, or may be integrated so that the boundaries between the layers are visually recognizable.

Each element body layer includes a resin material. The resin material includes, for example, at least one selected from the group consisting of liquid crystal polymer, polyimide resin, crystalline polystyrene, epoxy resin, acrylic resin, bismaleimide resin, and fluororesin. Each element body layer may include a filler in addition to the resin material. For example, the filler includes an inorganic filler. For example, the inorganic filler includes silica (SiO₂). Each element body layer may not include a filler. The element body 3 may have light transmittance. The element body 3 may be transparent or translucent for visible light.

The pair of external electrodes 5 is disposed on the main surface 3a. Each external electrode 5 includes an electrode portion 5a disposed on the main surface 3a. Each external electrode 5 may include only the electrode portion 5a. The pair of external electrodes 5 are separated from each other in the direction D2. The pair of external electrodes 5 may also be separated from each other in the direction D3. For example, each external electrode 5 has a rectangular shape when viewed in the direction D1. The contour of each external electrode 5, that is, the contour of each electrode portion 5a, may include a pair of sides opposing each other and extending along the direction D2, and another pair of sides opposing each other and extending along the direction D3.

Each external electrode 5 (each electrode portion 5a) includes a surface 5s exposed from the main surface 3a. For example, the surface 5s is not covered by the main surface 3a. For example, the surface 5s is substantially flush with the main surface 3a. Each external electrode 5 does not protrude from the main surface 3a. The surface 5s is included in an imaginary plane including the main surface 3a. Each external electrode 5 is disposed in a recess formed in the main surface 3a. Each external electrode 5 is positioned within the body 3 except for the surface 5s. The surface of each external electrode 5 is covered by the body 3 except for the surface 5s. For example, each external electrode 5 is not covered by the body 3 at the surface 5s. The surface 5s may be separated from the imaginary plane including the main surface 3a in the direction D1. For example, a part of each external electrode 5 including the surface 5s may protrude from the body 3.

Each external electrode 5 includes a conductive material. The conductive material includes, for example, Ag, Pd, Cu, or Al. The conductive material may include, for example, an Ag—Pd alloy, an Ag—Cu alloy, an Ag—Au alloy, or an Ag—Pt alloy.

A plating film (not illustrated) may be disposed on the surface 5s of each external electrode 5. The plating film is formed by electroplating or electroless plating, for example. The plating film includes, for example, a Ni plating film, a Sn plating film, a Cu plating film, or an Au plating film. The plating film may have a multilayer structure. The plating film may include, for example, a Ni plating layer and an Au plating layer. The Ni plating layer is formed on the surface 5s. The Au plating layer is formed on the Ni plating layer. The Au plating layer covers the Ni plating layer.

The main surface 3b is exposed from the pair of external electrodes 5. The pair of external electrodes 5 are not disposed on the main surface 3b. Each external electrode 5 does not include an electrode portion disposed on the main surface 3b. The main surface 3b is not covered by the pair of external electrodes 5. The entirety of the main surface 3b is exposed from the pair of external electrodes 5. For example, the entirety of the main surface 3b is not covered by the pair of external electrodes 5.

Each external electrode 5 may include an electrode portion disposed on a corresponding side surface 3c2 of the pair of side surfaces 3c₂. Each external electrode 5 may include electrode portions disposed on each of the pair of side surfaces 301. The electrode portion 5a may be continuous with the electrode portion disposed on the side surface 3c₂ and the electrode portions disposed on each of the pair of side surfaces 3c₁.

The chip electronic component CE1 includes an internal conductor (not illustrated). In a configuration in which the chip electronic component CE1 includes a coil component, for example, the internal conductor includes a plurality of coil conductors that are electrically connected to each other. In a configuration in which the chip electronic component CE1 includes a capacitor component, for example, the internal conductor includes a plurality of internal electrodes that oppose each other. Even in a configuration in which the chip electronic component CE1 includes a piezoelectric component, a varistor component, or a thermistor component, for example, the internal conductor includes a plurality of internal electrodes that oppose each other. As described above, for example, the internal conductor includes the plurality of coil conductors or the plurality of internal electrodes. The internal conductor is well-known in this technical field, and a detailed description thereof is omitted. The chip electronic component CE1 may include, in addition to the above-described electronic components, a composite component such as a filter component or a solid-state battery component.

A surface roughness of the outer surface of the element body 3 will be described with reference to FIGS. 2 and 3. FIGS. 2 and 3 include enlarged views of a part of the element body 3. FIGS. 2 and 3 schematically illustrate the cross-sectional configuration of the chip electronic component CE1. Therefore, the shape of the irregularities caused by the surface roughness of the outer surface (main surfaces 3a and 3b as well as side surfaces 3c) of the element body 3 illustrated in FIGS. 2 and 3 may be different from the shape of the actual irregularities.

The main surface 3b has a surface roughness larger than a surface roughness of the main surface 3a, and larger than a surface roughness of the side surface 3c. The surface roughness of the main surface 3a is smaller than the surface roughness of the side surface 3c. The surface roughness of the main surface 3a is defined by the surface roughness of the region of the main surface 3a that is not covered by the external electrode 5.

A configuration in which the main surface 3b has a large surface roughness is realized by polishing the main surface 3b, for example. In this case, the main surface 3b includes a polished surface. The polishing of the main surface 3b includes, for example, grinding or rough polishing the main surface 3b. The magnitude of the surface roughness of the main surface 3b can be adjusted by controlling the roughness of the grinding, for example.

The main surface 3a may include, for example, a polished surface. The side surface 3c may include, for example, a cut surface.

### [Electronic Component Package]

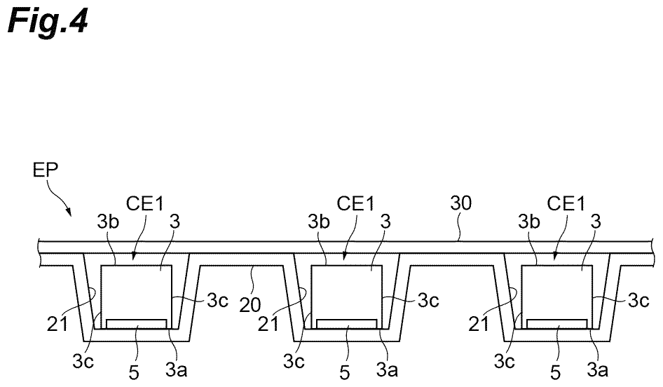

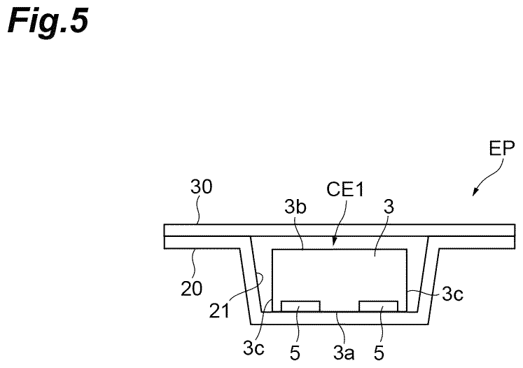

A configuration of an electronic component package EP will be described with reference to FIGS. 4 and 5. FIGS. 4 and 5 are views illustrating a cross-sectional configuration of the electronic component package. In FIGS. 4 and 5, hatching indicating the cross-section is omitted.

The electronic component package EP includes a plurality of chip electronic components CE1, a carrier tape 20, and a cover tape 30. The carrier tape 20 and the cover tape 30 include elongated or belt-shaped members.

The carrier tape 20 has a plurality of cavities 21. The plurality of cavities 21 are provided at predetermined intervals along the longitudinal direction of the carrier tape 20. Each cavity 21 has an opening.

The cover tape 30 is disposed on the carrier tape 20 to cover the plurality of cavities 21. The opening of each cavity 21 is covered by the cover tape 30. The cover tape 30 is joined to the carrier tape 20 to be peelable from the carrier tape 20.

Each chip electronic component CE1 is housed in a corresponding cavity 21 among the plurality of cavities 21. Each chip electronic component CE1 is inserted into the cavity 21 through the opening of the corresponding cavity 21. Each chip electronic component CE1 is taken out from the cavity 21 through the opening of the corresponding cavity 21.

Each chip electronic component CE1 is housed in the cavity 21 such that the main surface 3a opposes the bottom surface of the corresponding cavity 21. The main surface 3b faces the opening of the corresponding cavity 21. In the carrier tape 20, the main surface 3b is arranged to include a surface that faces the opening of the cavity 21. Each chip electronic component CE1 is housed in the corresponding cavity 21 such that the main surface 3b includes the surface that faces the opening of the corresponding cavity 21.

Each of the plurality of chip electronic components CE1 included in the electronic component package EP is taken out from the corresponding cavity 21 by being picked up by the nozzle of a mounter, for example. The main surface 3b is attracted to the nozzle by suction. The chip electronic component CE1 taken out from the corresponding cavity 21 is placed at a predetermined position on the electronic device by the mounter, in a state where the main surface 3b is attracted to the nozzle by suction. The chip electronic component CE1 is placed on the electronic device such that the main surface 3a opposes the electronic device. The chip electronic component CE1 placed on the electronic device is solder-mounted to the electronic device, for example. The electronic device includes, for example, a circuit board or an electronic component.

The main surface 3b of the chip electronic component CE1 included in the electronic component package EP faces the cover tape 30. The main surface 3b is exposed from the external electrode 5. For example, the main surface 3b is not covered by the external electrode 5. The main surface 3b tends to come into contact with the cover tape 30. For example, when transporting the electronic component package EP (chip electronic component CE1), the chip electronic component CE1 may move within the cavity 21 in a state where the main surface 3b is in contact with the cover tape 30. In this case, static electricity tends to be generated, and the chip electronic component CE1 (element body 3) may become electrostatically charged.

For example, when the cover tape 30 is peeled from the carrier tape 20, static electricity may be generated. In this case as well, the chip electronic component CE1 (element body 3) may become electrostatically charged.

The electrostatic charging of the chip electronic component CE1 can become a cause of mounting defects of the chip electronic component CE1, as described below.

For example, when the cover tape 30 is peeled from the carrier tape 20, the electrostatically charged chip electronic component CE1 may adhere to the cover tape 30 and be taken away from the cavity 21. In this case, the chip electronic component CE1 may not be mounted on the electronic device.

For example, when the cover tape 30 is peeled from the carrier tape 20, the electrostatically charged chip electronic component CE1 may rotate within the cavity 21 in association with the peeling of the cover tape 30. When the chip electronic component CE1 rotates within the cavity 21, the orientation of the chip electronic component CE1 within the cavity 21 changes. If the orientation of the chip electronic component CE1 within the cavity 21 changes, the main surface 3b may not be attracted to the nozzle by suction. If a surface other than the main surface 3b is attracted to the nozzle by suction, the chip electronic component CE1 may not be mounted on the electronic device such that the main surface 3a and the electronic device oppose each other. If the mounter cannot pick up the chip electronic component CE1, the chip electronic component CE1 may not be mounted on the electronic device.

As described above, in the chip electronic component CE1, the main surface 3b exposed from the external electrode 5 has the surface roughness larger than the surface roughness of the main surface 3a and larger than the surface roughness of the side surface 3c. A configuration in which the surface roughness of the main surface 3b is larger than the surface roughness of each of the main surface 3a and the side surface 3c reduces the contact area between the main surface 3b and the cover tape 30, as compared with a configuration in which the surface roughness of the main surface 3b is smaller than the surface roughness of each of the main surface 3a and the side surface 3c. Therefore, even when the chip electronic component CE1 moves within the cavity 21 in a state where the main surface 3b is in contact with the cover tape 30, static electricity tends not to be generated. Consequently, electrostatic charging of the chip electronic component CE1 (element body 3) tends not to occur. The element body 3 may include an element body made of resin.

The element body made of resin has a marked tendency to become electrostatically charged. However, in the chip electronic component CE1, since the surface roughness of the main surface 3b is larger than the surface roughness of each of the main surface 3a and the side surface 3c, even when the chip electronic component CE1 is housed in the carrier tape 20, the chip electronic component CE1 (element body 3) tends not to become electrostatically charged.

The chip electronic component CE1 may have a chip size of 0402 or less.

The chip electronic component CE1 having a chip size of 0402 or less has a smaller mass as compared with the chip electronic component CE1 having a chip size larger than 0402. Therefore, the chip electronic component CE1 having a chip size of 0402 or less has a marked tendency to cause mounting defects. However, in the chip electronic component CE1, since the surface roughness of the main surface 3b is larger than the surface roughness of each of the main surface 3a and the side surface 3c, the chip electronic component CE1 tends not to become electrostatically charged and tends not to cause mounting defects.

The electronic component package EP may include the plurality of chip electronic components CE1. Each chip electronic component CE1 may be housed in the cavity 21 such that the main surface 3b faces the opening of the cavity 21.

In the electronic component package EP, the main surface 3b may come into contact with the cover tape 30. However, since each chip electronic component CE1 has a configuration in which the surface roughness of the main surface 3b is larger than the surface roughness of each of the main surface 3a and the side surface 3c, even when the main surface 3b comes into contact with the cover tape 30, the chip electronic component CE1 (element body 3) tends not to become electrostatically charged.

### [Electronic Component Device]

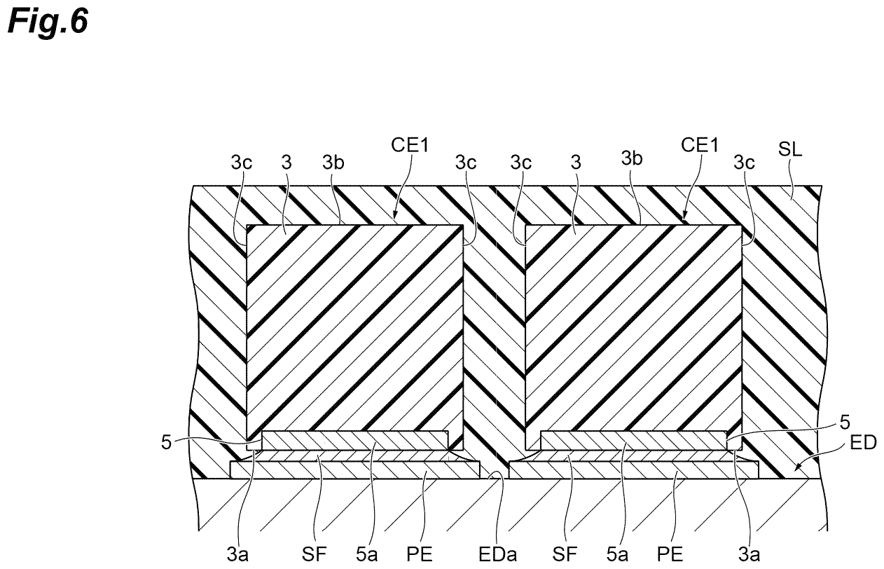

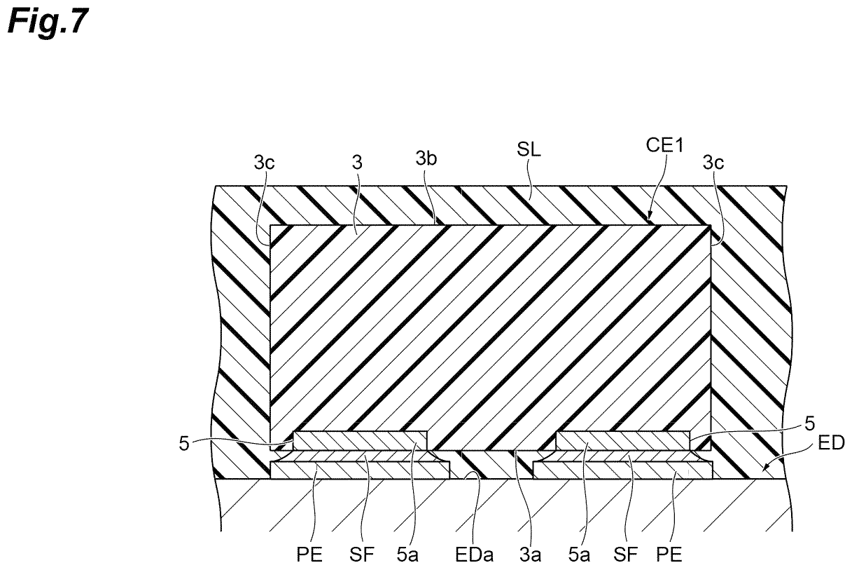

A configuration of the electronic component device will be described with reference to FIGS. 6 and 7. FIGS. 6 and 7 are views illustrating a cross-sectional configuration of the electronic component device.

The electronic component device includes, for example, a plurality of chip electronic components CE1, an electronic device ED, and an encapsulant SL. The electronic device ED includes, for example, a circuit board or an electronic component. Each chip electronic component CE1 is solder-mounted on the electronic device ED. In FIG. 6, two chip electronic components CE1 are illustrated, but the electronic component device may include a plurality of chip electronic components CE1 disposed in a matrix. The electronic device ED includes a main surface EDa and a plurality of pad electrodes PE. Each pad electrode PE is disposed on the main surface EDa. The plurality of pad electrodes PE are separated from each other. Each chip electronic component CE1 is disposed on the electronic device ED such that the main surface 3a and the main surface EDa oppose each other. The external electrode 5 and the pad electrode PE corresponding to each other are coupled via a solder fillet SF. The distance between the main surface 3a and the main surface EDa ranges from 20 to 30 μm, for example. The distance between the chip electronic components CE1 adjacent to each other ranges from 50 to 80 μm, for example. The distance between the main surface 3a and the main surface EDa is smaller than the distance between the chip electronic components CE1 adjacent to each other.

The encapsulant SL seals the plurality of chip electronic components CE1 mounted on the electronic device ED. The encapsulant SL covers each chip electronic component CE1. The encapsulant SL protects each chip electronic component CE1. The encapsulant SL has electrical insulating properties. The encapsulant SL includes, for example, a resin material. The resin material includes, for example, a silicone resin or an epoxy resin. The encapsulant SL is formed, for example, by using a molding process or a potting process.

The encapsulant SL includes a portion positioned between the chip electronic components CE1 adjacent to each other, and a portion positioned between each chip electronic component CE1 and the electronic device ED. The portion positioned between the chip electronic components CE1 adjacent to each other is in contact with each side surface 3c of the chip electronic components CE1 adjacent to each other. The portion positioned between the chip electronic components CE1 adjacent to each other is formed by curing a resin material that has entered between the side surfaces 3c of the chip electronic components CE1 adjacent to each other. The portion positioned between each chip electronic component CE1 and the electronic device ED is in contact with each main surface 3a and the main surface EDa. The portion positioned between each chip electronic component CE1 and the electronic device ED is formed by curing a resin material that has entered between each main surface 3a and the main surface EDa.

As described above, in the chip electronic component CE1, the surface roughness of the main surface 3b is larger than the surface roughness of each of the main surface 3a and the side surface 3c. That is, the surface roughness of each of the main surface 3a and the side surface 3c is smaller than the surface roughness of the main surface 3b.

A configuration in which the surface roughness of the main surface 3a and the side surface 3c is smaller than the surface roughness of the main surface 3b allows the uncured resin material to more easily enter between the chip electronic components CE1 adjacent to each other and between the chip electronic component CE1 and the electronic device ED, as compared with a configuration in which the surface roughness of the main surface 3a and the side surface 3c is greater than the surface roughness of the main surface 3b. Therefore, in the configuration where the surface roughness of the main surface 3a and the side surface 3c is smaller than the surface roughness of the main surface 3b, the sealing material SL reliably seals each chip electronic component CE1.

In the chip electronic component CE1, the main surface 3a may have a surface roughness smaller than the surface roughness of the side surface 3c.

In the electronic component device, the distance between the main surface 3a and the main surface EDa is smaller than the distance between the chip electronic components CE1 adjacent to each other. Therefore, the resin material before curing tends not to enter between the chip electronic component CE1 and the electronic device ED, as compared with between the chip electronic components CE1 adjacent to each other.

A configuration in which the surface roughness of the main surface 3a is smaller than the surface roughness of the side surface 3c allows the uncured resin material to more easily enter between the chip electronic component CE1 and the electronic device ED, as compared with a configuration in which the surface roughness of the main surface 3a is larger than the surface roughness of the side surface 3c. Therefore, in the configuration in which the surface roughness of the main surface 3a is smaller than the surface roughness of the side surface 3c, the encapsulant SL is reliably disposed between the chip electronic component CE1 and the electronic device ED.

### [Pickup Test]

The surface roughness of the main surface 3b will be described. The present inventors conducted a pickup test in order to clarify the surface roughness of the main surface 3b. In this pickup test, the present inventors prepared samples S1 and S2 having different surface roughness on the main surface 3b, and determined the pickup rate for each sample S1 and S2. Each sample S1 and S2 is a lot including a plurality of specimens. The specimens of each sample S1 and S2 have the same configuration as the chip electronic component CE1, except that the surface roughness of the main surface 3b is different.

In this pickup test, the surface roughness is defined by the arithmetic mean height Sa. The arithmetic mean height Sa is defined in “ISO 25178 Surface Texture (Surface Roughness Measurement)”. In sample S1, the arithmetic mean height Sa of the main surface 3b is 0.4 μm. In sample S2, the arithmetic mean height Sa of the main surface 3b is 0.2 μm.

For each of the samples S1 and S2, an electronic component package including the plurality of specimens was prepared. The plurality of specimens are housed in a plurality of cavities such that the main surface 3b faces the opening of the cavity.

Using a mounter, each specimen was picked up from the electronic component package and continuously placed on the test substrate. The test substrate includes a number of electrode pads corresponding to the number of specimens to be placed on the test substrate. Solder paste is applied to each electrode pad. In this pickup test, 10,000 specimens were picked up from the electronic component package and placed on the test substrate.

The number of specimens placed such that the main surface 3a opposes the test substrate was counted, and the pickup rate was calculated. The pickup rate is a value expressed as a percentage, obtained by dividing the counted number by 10,000 and then multiplying by 100.

The pickup rate in Sample S1 was 98.35%. The pickup rate in Sample S2 was 44.44%.

In Sample S2, upon inspection of the electronic component package, a specimen adhering to the cover tape peeled from the carrier tape was observed. In Sample S2, upon inspection of the specimen picked up by the mounter, a specimen was observed in which a portion other than the main surface 3b was attracted to the nozzle by suction. The specimen in which a portion other than the main surface 3b was attracted to the nozzle by suction includes, for example, a specimen in which the side surface 3c is attracted to the nozzle by suction, or a specimen in which the ridge portion of the element body 3 is attracted to the nozzle by suction.

In contrast, in Sample S1, no specimen adhering to the cover tape, nor any specimen attracted to the nozzle by suction at portions other than the main surface 3b, was observed.

Based on the results of the pickup test, it is presumed that, in the specimen of Sample S1, even when housed in the carrier tape, electrostatic charging tends not to occur as compared with in the specimen of Sample S2.

In a configuration in which the arithmetic mean height Sa of the main surface 3b is 0.4 μm or more, the chip electronic component CE1 (element body 3) tends not to become reliably electrostatically charged.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A chip electronic component comprising:
an element body including a first main surface arranged to constitute a mounting surface, a second main surface opposing the first main surface, and a side surface adjacent to the first main surface and the second main surface; and
an external electrode including an electrode portion that is disposed on the first main surface,
wherein the second main surface is exposed from the external electrode, and has a surface roughness larger than a surface roughness of the first main surface and larger than a surface roughness of the side surface.

2. The chip electronic component according to claim 1, wherein
an arithmetic mean height Sa of the second main surface is in a range of 0.4 μm or more.

3. The chip electronic component according to claim 1, wherein
the surface roughness of the first main surface is smaller than the surface roughness of the side surface.

4. The chip electronic component according to claim 1, wherein
the element body includes an element body made of resin.

5. The chip electronic component according to claim 1, wherein
the chip electronic component has a chip size of 0402 or less.

6. The chip electronic component according to claim 5, wherein
the chip electronic component has a chip size of 0201.

7. The chip electronic component according to claim 1, wherein
the chip electronic component is arranged to disposed in a cavity of a carrier tape, and
in the cavity, the second main surface is arranged to include a surface that faces an opening of the cavity of the carrier tape.

8. The chip electronic component according to claim 1, wherein
the chip electronic component includes a coil component.

9. An electronic component package comprising:
a chip electronic component including an element body and an external electrode;
a carrier tape having a cavity in which the chip electronic component is accommodated; and
a cover tape that covers an opening of the cavity,
wherein the element body includes a first main surface arranged to constitute a mounting surface, a second main surface opposing the first main surface, and a side surface adjacent to the first main surface and the second main surface,
the external electrode includes an electrode portion that is disposed on the first main surface,
the second main surface is exposed from the external electrode, and has a surface roughness larger than a surface roughness of the first main surface and larger than a surface roughness of the side surface, and
the chip electronic component is housed in the cavity such that the second main surface includes a surface that faces the opening of the cavity.

10. The electronic component package according to claim 9, wherein
an arithmetic mean height Sa of the second main surface is in a range of 0.4 μm or more.

11. The electronic component package according to claim 9, wherein
the surface roughness of the first main surface is smaller than the surface roughness of the side surface.

12. The electronic component package according to claim 9, wherein
the element body includes an element body made of resin.

13. The electronic component package according to claim 9, wherein
the chip electronic component has a chip size of 0402 or less.

14. The electronic component package according to claim 13, wherein
the chip electronic component has a chip size of 0201.

15. The electronic component package according to claim 9, wherein
the chip electronic component includes a coil component.
